(19) United States
(12) Patent Application Publication
(10) Pub. No.: US 2012/0124228 A1
(43) Pub. Date: May 17, 2012

(54) MULTIMEDIA SESSION TRANSFER CONTROL SYSTEM AND METHOD

(75) Inventors: Cho-Rong YU, Daejeon-si (KR); Hwa-Shin MOON, Daejeon-si (KR); Dong-Hun LEE, Daejeon-si (KR); Jae-Chan SHIM, Daejeon-si (KR); Hwa-Suk KIM, Daejeon-si (KR); Sang-Kwon KIM, Daejeon-si (KR); Kang-Suk HUH, Chungcheongbuk-do (KR); Kee-Seong CHO, Daejeon-si (KR)

(73) Assignee: Electronics and Telecommunications Research Institute, Daejeon-si (KR)

(21) Appl. No.: 13/293,614

(22) Filed: Nov. 10, 2011

(30) Foreign Application Priority Data
Nov. 11, 2010 (KR) 10-2010-0112142

(51) Int. Cl. G06F 15/16

(52) U.S. Cl. 709/228

(57) ABSTRACT

A multimedia session transfer control system and method are provided. The multimedia session transfer control system includes a service transfer control server configured to issue a session transfer message including information on transfer of a session when the session between a receiving terminal and a transmitting terminal is transferred; and a service providing server configured to receive the session transfer message, identify a multimedia service corresponding to the session transfer, change an execution rule for the multimedia service, and provide the multimedia service whose execution rule has been changed from the transmitting terminal to the receiving terminal.

### CROSS REFERENCE TO RELATED APPLICATION

This application claims the benefit under 35 U.S.C. §119(a) of Korean Patent Application No. 10-2010-0112142, filed on Nov. 11, 2010, the entire disclosure of which is incorporated herein by reference for all purposes.

### BACKGROUND

1. Field

The following description relates to a multimedia session transfer control system and method, and more particularly, to a multimedia session transfer control system and method for reflecting a session transfer event to a service execution procedure by being notified of session transfer between terminals or networks.

2. Description of the Related Art

IP multimedia subsystem defined by the 3^{RD} generation partnership project (3GPP) is an architectural framework which can allow communication service providers to provide users with various multimedia services over an IP network through session initiation protocol (SIP)-based session control. IMS is regarded as the standard for the core control architecture of the next generation wired/wireless integrated network. Also, IMS is associated with a network transport layer for efficiently providing an IP multimedia service, allowing easy development of a variety of application services, and particularly, allowing third-party service providers, other than the communication service providers, to be able to develop IMS associated services using an open access structure.

IMS service platform is designed for control of a session established between peers. IMS only deals with signaling and control of a session, and does not involve with actual data transfer. IMS uses SIP, defined as a standard protocol by the Internet Engineering Task Force (IETF), as process protocol for processing a call between peers.

An IMS-based mobile communication network supports terminal mobility which enables a user to be consistently provided with a multimedia service as well as calls through a terminal even when the user is in motion. Specifically, with the increasing diverse wireless connection technologies, technologies for allowing one terminal to simultaneously use a plurality of mobile access methods have been developed. In addition, studies on technologies for consistent provision of a multimedia service and calls from one terminal to another terminal among a plurality of terminals of one user have been conducted.

### SUMMARY

Accordingly, in one aspect, there is provided a multimedia session control system and method for preventing a terminal restriction or session collision by notifying a multimedia service providing side of a service transfer by notification and applying an execution rule of each of various multimedia services.

In one general aspect, there is provided a multimedia session transfer control system including: a service transfer control server configured to issue a session transfer message including information on transfer of a session when the session between a receiving terminal and a transmitting terminal is transferred; and a service providing server configured to receive the session transfer message, identify a multimedia service corresponding to the session transfer, change an execution rule for the multimedia service, and provide the multimedia service whose execution rule has been changed from the transmitting terminal to the receiving terminal.

Other features and aspects will be apparent from the following detailed description, the drawings, and the claims.

### BRIEF DESCRIPTION OF THE DRAWINGS

FIG. 1 is a diagram illustrating an example of a multimedia session transfer control system.

FIG. 2 is a diagram illustrating an example of a configuration of the service transfer control server illustrated in FIG. 1.

FIG. 3 is a diagram illustrating an example of a session information message.

FIG. 4 is a diagram illustrating an example of a configuration of the service session information included in the session information message illustrated in FIG. 3.

FIG. 5 is a diagram illustrating an example of a configuration of the service providing server illustrated in FIG. 1.

FIG. 6 is a diagram illustrating an example of a configuration of the service storage unit illustrated in FIG. 5.

FIG. 7 is a flowchart illustrating procedures of transferring a session of a multimedia service in the multimedia session transfer control system illustrated in FIG. 1.

FIG. 8 is a flowchart illustrating procedures of providing a multimedia service after the transfer of a session in the multimedia session transfer control system illustrated in FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

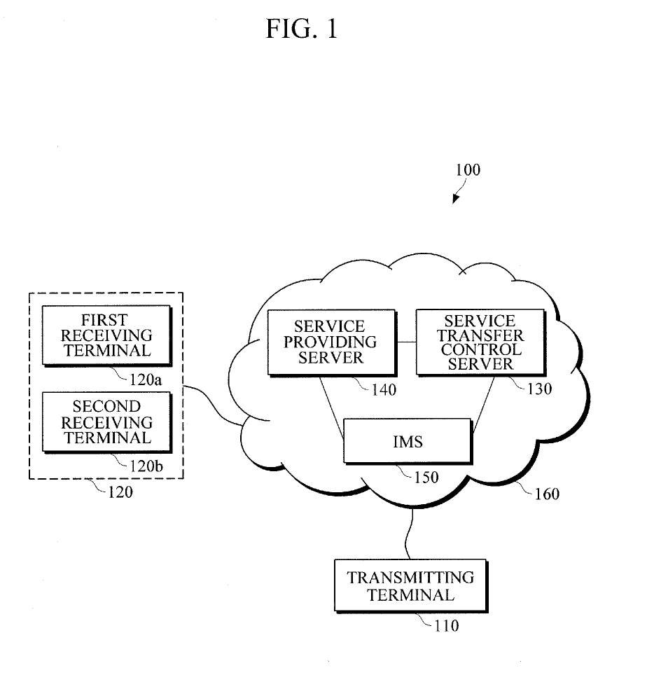

FIG. 1 is a diagram illustrating an example of a multimedia session transfer control system.

Referring to FIG. 1, multimedia session transfer control system may include a transmitting terminal 110, a receiving terminal 120, a service transfer control server 130, and a service providing server 140. The service transfer control server 130 and the service providing server 140 are connected to an IP multimedia subsystem (IMS) 150, and the transmitting terminal 110, the receiving terminal 120, and the IMS 150 are connected to one another via a network 160.

The transmitting terminal 110 provides at least two multimedia through a multimedia service using a plurality of sessions. More specifically, the transmitting terminal 110 may classify the multimedia into session A-1 and session A-2 and transfer the sessions A-1 and A-2 to the receiving terminal 120. The transmitting terminal 110 may or not recognize that the multimedia are connected via the session A-1 and the session A-2.

The transmitting terminal 120 receives the multimedia transferred from the transmitting terminal 110 through the network 160, and includes a first receiving terminal 120a and a second transmitting terminal 120b. The first receiving terminal 120a receives multimedia through the session A-1 and the second receiving terminal 120b receives another multimedia through the session A-2. In this case, the multimedia transferred through the session A-1 and the multimedia transferred through the session A-2 are transferred to the first and second receiving terminals 120a and 120b, respectively, according to specific service executing rules.

The service transfer control server 130 may recognize the change in terminals or networks during a multimedia service, and allow transfer of a session to a different terminal or network. In addition, the service transfer control server 130 may notify the service providing server 140 of the transfer of a session. Examples of multimedia service transfer may include a case in which during the transmitting terminal 110 transfers two or more multimedia, one specific multimedia is moved to a specific terminal or a new session is established through which the multimedia service can be provided by changing a specific multimedia session to a different network. When the service transfer control server 130 moves a specific multimedia to the second receiving terminal 120b while the transmitting terminal 110 transfers two or more multimedia toward the first receiving terminal 120a, the service transfer control server 130 transfers one of the multimedia components to the first receiving terminal 120a through the session A-1 and the specific multimedia component to the second receiving terminal 120b through the session A-2. Also, when a network over which the transmitting terminal 110 and the receiving terminal 120 are connected to each other is changed to a new network, the service transfer control server 130 may change an ongoing session of transferred multimedia to another session and allow the multimedia to be continuously transferred to the receiving terminal 120.

The service providing server 140 is where an IMS-based service is actually present and performed. The service providing server 140 may use multiple media provided by the transmitting terminal 110 to provide the receiving terminal with a multimedia service with a predetermined execution rule. The service providing server 140 may obtain information regarding the transferred session through session transfer notification transmitted from the service transfer control server 130 and select an appropriate multimedia service based on the information, and allow the selected multimedia service to be transferred from the transmitting terminal 110 to the receiving terminal 120.

The multimedia service provided by the service providing server 140 may allow multimedia components transferred from the transmitting terminal 110 to be provided to the receiving terminal 120 according to predetermined execution rules. Although only one service providing server 140 is illustrated in FIG. 1, one or more service providing servers to provide different multimedia services may be connected to the service transfer control server 130.

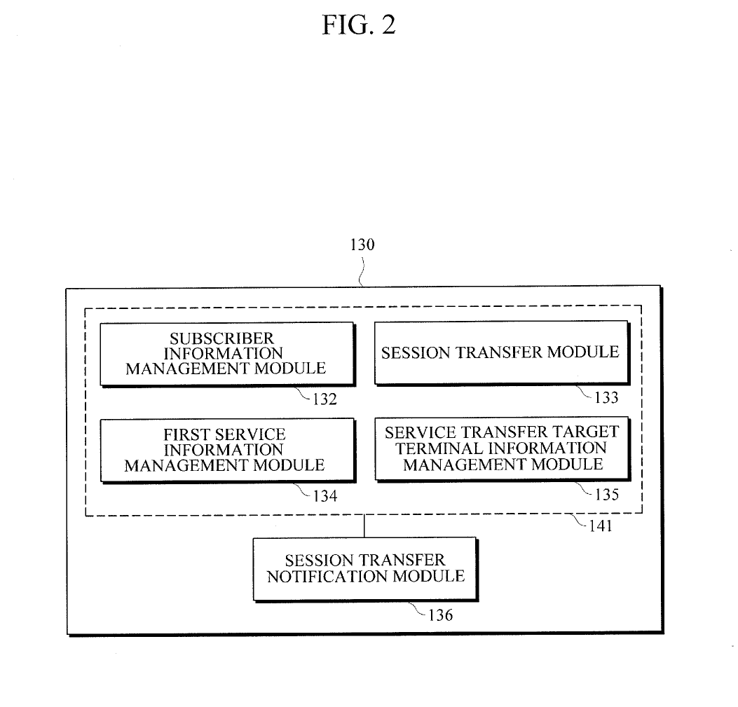

FIG. 2 is a diagram illustrating an example of a configuration of the service transfer control server illustrated in FIG. 1.

Referring to FIG. 1, the service transfer control server 130 may include a service transfer function module 141 and a session transfer notification module 136. The service transfer function module 141 may include a subscriber information management module 132, a session transfer module 133, a first service information management module 134, and a service transfer target terminal information management module 135.

The subscriber information management module 132 may receive information on a subscriber of an IMS-based multimedia service, and store and manage the received information. The subscriber information management module 132 may obtain information on a terminal registered and used by the subscriber through the service transfer target device information management module 135, that is, information on a transmitting terminal 110 and a receiving terminal 120 which are available to a user. In addition, the subscriber information management module 132 may map the obtained subscriber information and the terminal information, and obtain and manage information about services and terminals used by each subscriber.

The session transfer module 133 may transfer a particular session of a multimedia service to a specific terminal or network. That is, when the transmitting terminal 110 initiates the transfer of a different multimedia component during transferring a multimedia component to the first receiving terminal 120a, the session transfer module 133 moves a session so that the ongoing multimedia component can be transferred to the first receiving terminal 120a through the session A-1 and the new different multimedia component can be transferred to the second receiving terminal 120b through the session A-2.

The first service information management module 134 may store and manage a list of multimedia services available to a predetermined subscriber, a list of currently executing multimedia, mapping information between the currently executed multimedia service, the transmitting terminal 110 and the receiving terminal 120, mapping information between a multimedia service and individual sessions present in the multimedia service, and detailed information on each individual session. The first service information management module 134 may obtain information on the subscriber and the terminal used by the subscriber through the subscriber information management module 132 to identify a multimedia service to be offered to the subscriber's terminal.

The service transfer target terminal information management module 135 may manage information on the transmitting terminal 110 to provide the multimedia component and the receiving terminals 120 to be offered the multimedia component. Moreover, the service transfer target terminal information management module 135 receives the information on the subscriber to be provided with the multimedia service associated with the transmitting terminal 110 and the receiving terminal 120 from the subscriber information management module 132, determines a terminal as a target of the service transfer based on the information on the subscriber, and stores and manages the determination result. In other words, the service transfer target terminal information management module 135 recognizes the information on the transmitting terminal 110 and the receiving terminal 120, and thereby the multimedia service available to the transmitting terminal 110 and the receiving terminal 120 can be identified.

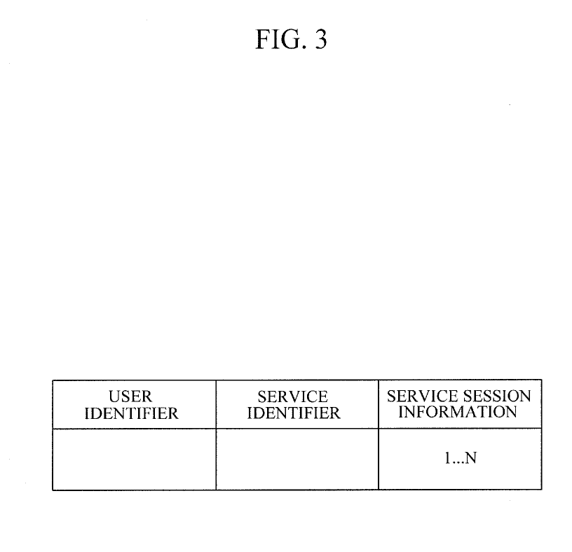

The session transfer notification module 136 notifies the service providing server 140 of the transfer of a session when the session transfer module 133 transfers the session, and transmits information regarding the multimedia service and terminal information to the service providing server 140. The session transfer notification module 136 may issue a session information message as illustrated in FIG. 3 to notify of the transfer of a session.

FIG. 3 is a diagram illustrating an example of a session information message.

Referring to FIG. 3, the session information message may include a user identifier of a current service user, a service identifier, and service session information. The service session information includes the same number of pieces of service session information as the number of sessions in the service.

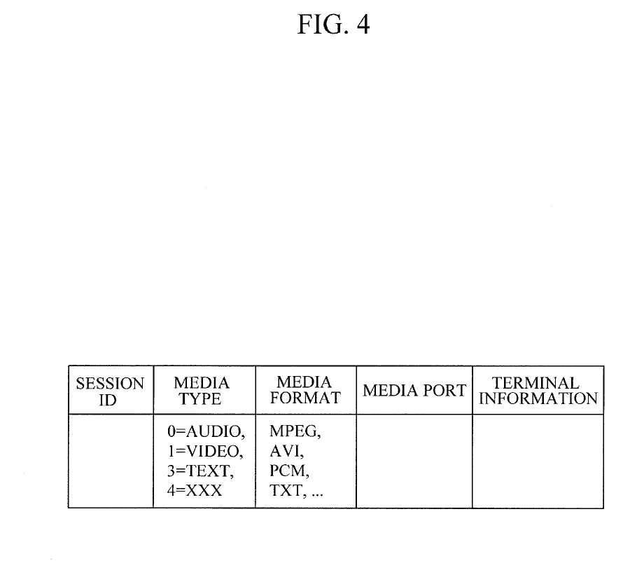

FIG. 4 is a diagram illustrating an example of a configuration of the service session information included in the session information message illustrated in FIG. 3.

Referring to FIG. 4, the service session information includes a session ID, a media type, a media form, a media port, and terminal information. The media type may define types of multimedia that a local IMS can provide and store the types as a list.

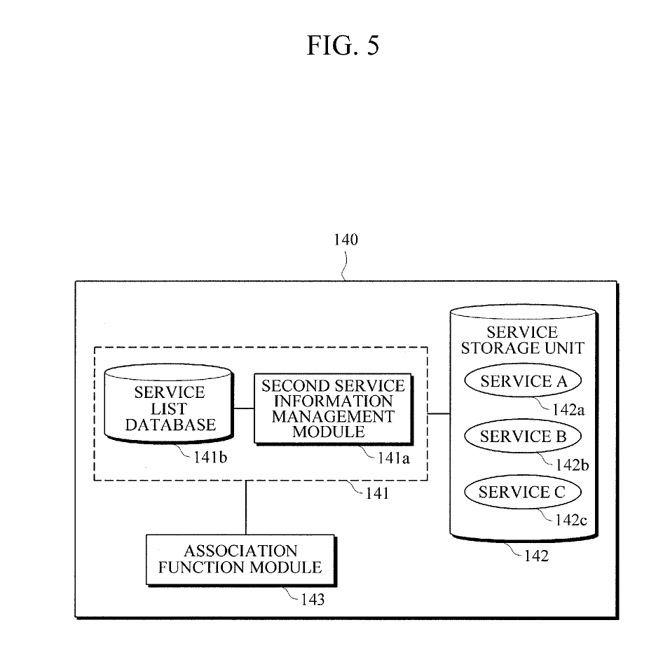

FIG. 5 is a diagram illustrating an example of a configuration of the service providing server illustrated in FIG. 1. Referring to FIG. 5, the service providing server 140 may include a service management function module 141, a service storage unit 142, and an association function module 143. In addition, the service management function module 141 may include a second service information management module 141a and a service list database 141b.

The second service information management module 141a may be connected to the service storage unit 142 to extract a service corresponding to the multimedia service from the service storage unit 142.

The service storage unit 142 may store a plurality of services including service A 142a, service B 142b, and service C 142C, which have information regarding the multimedia service, and provide one of the services 142a, 142b, and 142c to the second service information management module 141a.

The service list database 141B may store information on the multimedia service provided by the service providing server 140. Thus, if a session is transferred, the service transfer control server 130 determines whether a requested multimedia service is present in the service list database 141b, and then, depending on the determination result, checks whether the multimedia service can be provided by the service providing server 140.

In response to receiving information about transfer of a session through the session transfer notification module 136 of the service transfer control server 130, the association function module 143 notifies information about the transfer of a session to the service management function module 141. In this case, the association function module 143 determines whether the service providing server 140 provides a multimedia service to the transmitting terminal 110 and the receiving terminal 120 by searching the service list database 141b. If the service providing server 140 provides all multimedia services, the association function module 143 may simply bypass the information about the transfer of a session and transmit it to the service management function module 141.

The second service information management module 141a may select from the service storage unit 142 a service to be transmitted to the transmitting terminal 110 and the receiving terminal 120. That is, the second service information module 141a selects one from the service A 142a, the service B 142b, and the service C 142c which are stored in the service storage unit 142. Then, the second service information management module 141a provides the multimedia component provided by the transmitting terminal 110 to the receiving terminal 120 according to a predetermined execution rule recorded in a service of the multimedia service.

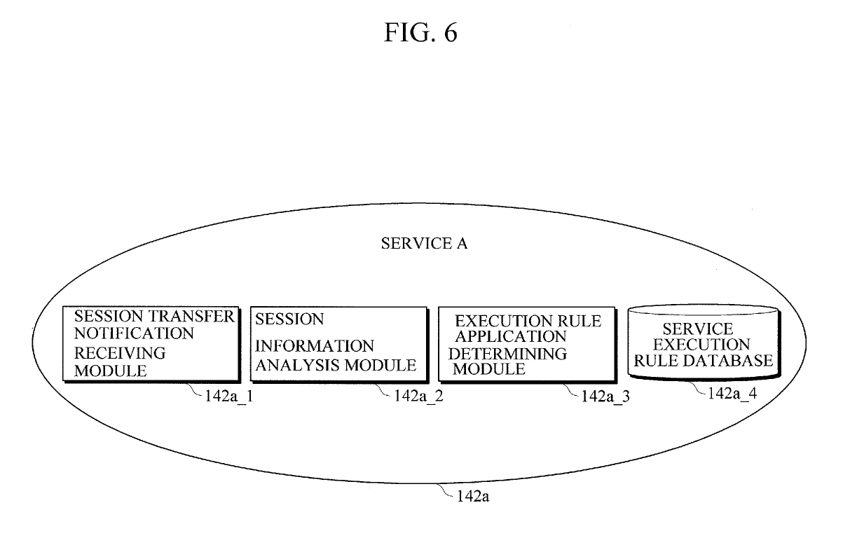

FIG. 6 is a diagram illustrating an example of a configuration of the service storage unit illustrated in FIG. 5. Referring to FIG. 6, the service A 142a includes a session transfer notification receiving module 142a_1, a session information analysis module 142a_2, an execution rule application determining module 142a_3, and a service execution rule database 142a_4.

The session transfer notification receiving module 142a_1 may receive session information from the service transfer control server 130 and transmit the session information to the session information analysis module 142a_2, and the session information analysis module 142a_2 may analyze the session information and transmit the analysis result to the execution rule application determining module 142a_3. The execution rule application determining module 142a_3 may map the analyzed session information and the service execution rules stored in the service execution rule database 142a_4, and allow the service A 142a to be executed according to the service execution rules.

The definition of the service execution rules may vary according to the characteristics of services, and thus a general definition of the service execution rules cannot be made. The contents of the execution rules can be conjectured from the above examples. For example, if there is an execution rule that a terminal supporting an IPTV broadcast program and a video call stops reproducing an IPTV broadcast program upon detecting an incoming video call and receives the video call, and then resumes reproducing the IPTV broadcast program once the video call is ended, the terminal is restricted to execute only one multimedia service having a higher priority. In contrast, when two multimedia services including the IPTV broadcast program and a video call are split into two sessions, each of the receiving terminals 120 can output one multimedia, and thus there is no restriction to output only one multimedia having a higher priority, and a number of multimedia can be displayed on the receiving terminals 120 according to various execution rules.

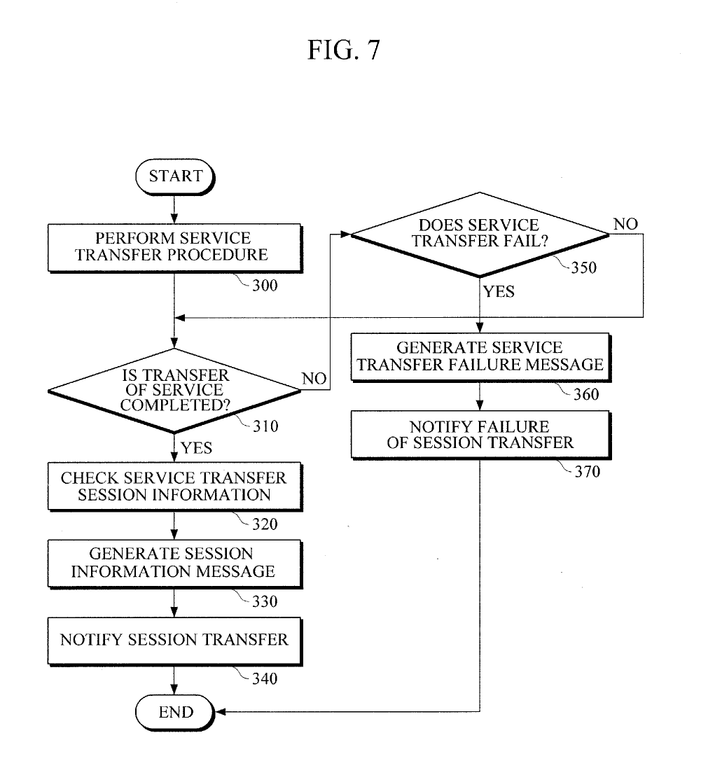

FIG. 7 is a flowchart illustrating procedures of transferring a session of a multimedia service in the multimedia session transfer control system illustrated in FIG. 1.

Referring to FIG. 7, if two or more multimedia services are transferred to the first receiving terminal 120a and the second receiving terminal 120b from the transmitting terminal 110, or if a service transfer occurs in which a network over which the transmitting terminal 110 and the receiving terminals 120 are connected is changed, service transfer initiates in operation 300. The service transfer control server 130 checks the service transfer in operation 310. In response to the confirmation of the service transfer, the service transfer control server 130 may check information on a subscriber and information on a terminal that is mapped to the subscriber from the subscriber information management module 132, and checks information about all multimedia services available to the subscriber from the first service information management module 134 to identify information on a session to which the multimedia is to be provided through the session transfer module 133. In addition, the session transfer notification function module 136 uses the aforementioned information to generate a session information message in operation 330, and transmits the generated session information message to the service providing server 140 in operation 340.

Thereafter, the service transfer control server 130 confirms that the service transfer has not been completed, and determines whether the service transfer fails in operation 350. If the service transfer failure is not confirmed, the service transfer is performed again, and otherwise, a service transfer failure message is generated in operation 360. Then, the service transfer control server 130 transmits the service transfer failure message to the transmitting terminal 110 and the receiving terminal 120 in operation 370.

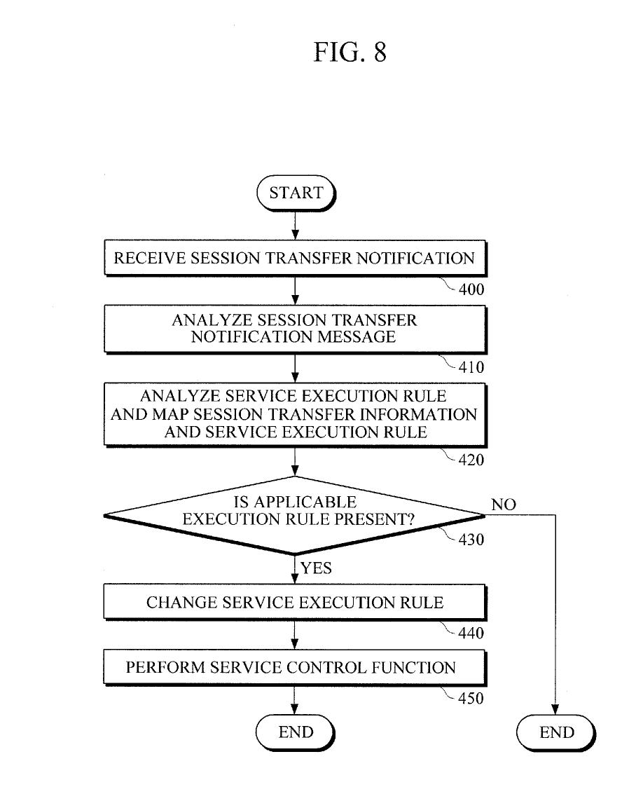

FIG. 8 is a flowchart illustrating procedures of providing a multimedia service after the transfer of a session in the multimedia session transfer control system illustrated in FIG. 1.

Referring to FIG. 8, the service providing server 140 receives a session transfer notification from the service transfer control server 130. In other words, the service providing server 140 receives a session information message from the service transfer control server 130 in operation 400. Based on a list of services stored in the service list database 141b, the service providing server 140 determines whether a multimedia service using a multimedia transmitted from the transmitting terminal 110 to the receiving terminal 120 is provided in operation 410. Then, the service providing server 140 checks the multimedia service included in the list of services stored in the service list database 141b, and analyzes the transferred session and execution rules of the multimedia. The service providing server 140 maps the session transfer information and the service execution rules. The service providing server 140 maps the execution rules and determines whether an application execution rule is present among the service A 142a, the service B 142b, and the service C 142c in operation 430. If there is no applicable execution rule, the service providing server 140 notifies that it is not possible to provide a multimedia service. If there is an applicable execution rule among the service A 142a, the service B 142b, and the service C 142c, the applicable execution rule is applied to the multimedia, thereby changing an execution rule for the multimedia service to be executed in operation 450. In addition, according to the changed execution rule, the multimedia is transferred from the transmitting terminal 110 to the receiving terminal 120, thereby providing the multimedia service to the receiving terminal 120 in operation 460.

As illustrated in the above examples, when a specific multimedia session is transferred between terminals or networks during the execution of a multimedia service, the session transfer is notified and various execution rules in consideration of service environment changes may be applied to the multimedia service. Accordingly, a variety of service execution methods can be offered, so that the convenience and efficiency of use of the multimedia service can be improved.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia session transfer control system comprising:
a service transfer control server configured to issue a session transfer message including information on transfer of a session when the session between a receiving terminal and a transmitting terminal is transferred; and
a service providing server configured to receive the session transfer message, identify a multimedia service corresponding to the session transfer, change an execution rule for the multimedia service, and provide the multimedia service whose execution rule has been changed from the transmitting terminal to the receiving terminal.

2. The multimedia session transfer control system of claim 1, wherein the service transfer control server is further configured to comprise
a subscriber information management module configured to obtain information on a subscriber who uses an IP multimedia subsystem (IMS)-based multimedia service, and store and manage the obtained information,
a session transfer module configured to transfer a specific session of a multimedia service to a specific terminal or network,
a first service information management module configured to store and manage a plurality of information including a list of multimedia services available to a particular subscriber, a list of currently executed multimedia, mapping information between currently executed multimedia services, a transmitting terminal, and a receiving terminal, mapping information between a multimedia service and individual sessions present in the multimedia service, and detailed information on each individual session, and
a service transfer target terminal information management module configured to manage information on a transmitting terminal that provides multimedia and receiving terminals that receive the multimedia.

3. The multimedia session transfer control system of claim 2, wherein the subscriber information management module is further configured to acquire information on a transmitting terminal and a receiving terminal which are available to a user through the service transfer target device information management module.

4. The multimedia session transfer control system of claim 3, wherein the subscriber information management module is further configured to map the obtained subscriber information and information on a terminal, and obtain and manage information on a service and a terminal which are used by each subscriber.

5. The multimedia session transfer control system of claim 2, wherein the first service information management module is further configured to acquire information on a subscriber and information on a terminal used by the subscriber through the subscriber information management module and check a multimedia service to be provided to the terminal of the subscriber.

6. The multimedia session transfer control system of claim 2, wherein the service transfer target terminal information management module is further configured to receive information on a subscriber to be provided with a multimedia service from the subscriber information management module, determine a terminal to be a target of service transfer, and store and manage the determination result.

7. The multimedia session transfer control system of claim 6, wherein the service transfer target terminal information management module is further configured to determine a multimedia service available to a transmitting terminal and a receiving terminal by analyzing information on the transmitting terminal and the receiving terminal.

8. The multimedia session transfer control system of claim 2, wherein the service transfer control server is further configured to further comprise a session transfer notification module configured to notify the session transfer when the session is transferred by the session transfer module and transmit information on a multimedia service and terminal information to the service providing server.

9. The multimedia session transfer control system of claim 8, wherein the session transfer notification module is further configured to notify the session transfer using a session information message including a user identifier of a current service user, a service identifier, and session information.

10. The multimedia session transfer control system of claim 2, wherein the service providing server is further configured to comprise
a second service information management module configured to select a service to be provided to a transmitting terminal and a receiving terminal and provide a multimedia transmitted from the transmitting terminal to the receiving terminal by applying a predetermined execution rule recorded in the selected service to a multimedia service,
a service storage unit configured to store services that include information regarding the multimedia service, and provide one of the stored services to the second service information management module, and
an association function module configured to transmit information on the session transfer to the service management function module when receiving the information on the session transfer from the session transfer notification module of the service transfer control server.

11. The multimedia session transfer control system of claim 10, wherein the service management function module is further configured to comprise a service list database to store information on a multimedia service provided by the service providing server.

12. The multimedia session transfer control system of claim 10, wherein the second service information management module is further configured to extract a service to be applied to the multimedia service from the service storage unit.

13. The multimedia session transfer control system of claim 11, wherein the service transfer control server is further configured to determine whether a requested multimedia service is present in the service list database when a session is transferred, and according to the determination result, check whether the requested multimedia service can be provided by the service providing server.

14. The multimedia session transfer control system of claim 11, wherein the association function module is further configured to determine whether a multimedia service to be provided between the transmitting terminal and the receiving terminal is provided by the service providing server with reference to the service list database.

15. The multimedia session transfer control system of claim 14, wherein the association function module is further configured to bypass information on session transfer and transmit the information to the service management function module if the service providing server provides all multimedia services.
